(19) United States
(12) Patent Application Publication
(10) Pub. No.: US 2025/0086433 A1
(43) Pub. Date: Mar. 13, 2025

(54) METHOD AND APPARATUS WITH GRAPH PROCESSING USING NEURAL NETWORK

(71) Applicants: Samsung Electronics Co., Ltd., Suwon-si (KR); IUCF-HYU (Industry-University Cooperation Foundation Hanyang University), Seoul (KR)

(72) Inventor: Kijung YOON, Seoul (KR)

(73) Assignees: Samsung Electronics Co., Ltd., Suwon-si (KR); IUCF-HYU (Industry-University Cooperation Foundation Hanyang University), Seoul (KR)

(21) Appl. No.: 18/601,523

(22) Filed: Mar. 11, 2024

(30) Foreign Application Priority Data
Sep. 13, 2023 (KR) 10-2023-0121988

(51) Int. Cl. G06N 3/0455; G06N 3/0985

(52) U.S. Cl. CPC G06N 3/0455; G06N 3/0985

(57) ABSTRACT

A method and apparatus for graph processing using a neural network model are provided. The method includes generating messages based on node states of nodes of input graph data using a neural message generating model, generating aggregated messages by aggregating the messages based on the nodes, updating the node states of the nodes by executing different neural update models, and outputting a task result with respect to the input graph data based on the updated node states.

### CROSS-REFERENCE TO RELATED APPLICATIONS

This application claims the benefit under 35 USC § 119 (a) of Korean Patent Application No. 10-2023-0121988, filed on Sep. 13, 2023, in the Korean Intellectual Property Office, the entire disclosure of which is incorporated herein by reference for all purposes.

### BACKGROUND

### 1. Field

The following examples relate to a method and apparatus with graph processing using a neural network model.

### 2. Description of Related Art

Technical automation of a recognition process has been implemented through a neural network model implemented, for example, by a processor as a special computing structure, which provides intuitive mapping for computation between an input pattern and an output pattern after training that is sometimes considerable. Such a trained capability of generating the mapping may be referred to as a learning ability of the neural network model. Furthermore, a neural network model trained and specialized through special training has, for example, a general ability to provide a relatively accurate output with respect to an input pattern not specifically trained for.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a graph processing method is performed by a computing device including processing hardware and storage hardware, and the method includes: generating, by the processing hardware, and storing in the storage hardware, messages based on node states of nodes of input graph data stored in the storage hardware using a neural message generating model stored in the storage hardware; generating, by the processing hardware, aggregated messages by aggregating the messages; updating the node states of the nodes by applying a first neural update model and a second neural update model to the aggregated messages; and outputting an inference with respect to the input graph data based on the updated node states.

The messages may be generated by executing the neural message generating model based on the node states of the nodes, embedding features of the nodes, and edges of the nodes.

The first neural update model may have a different architecture or different parameters than the second neural update model.

The updating of the node states may include, by the processing hardware: determining a first intermediate node state of a first node, among the nodes, by applying the first neural update model to a first aggregated message, among the aggregated messages, that is aggregated at the first node; determining a second intermediate node state of the first node by applying the second neural update model to the first aggregated message; and updating a state of the first node by fusing the first intermediate node state and the second intermediate node state.

The method may further include: determining a fusion coefficient by executing a neural fusion model based on the input graph data; and performing the fusing of the first intermediate node state and the second intermediate node state based on the fusion coefficient.

The updating of the node states may include: selecting a representative neural update model from between the first and second neural update models; updating a first node state of a first node of the nodes by applying the first neural update model to a first aggregated message of the aggregated messages aggregated at the first node, based on the first neural update model being selected as the representative neural update model; and updating the first node state by applying the second neural update model to the first aggregated message, when the second neural update model is selected as the representative neural update model.

The representative neural update model may be selected based on a probability model.

The probability model may be a neural probability model configured to generate probability values for selecting the representative neural update model based on the input graph data.

The updating of the node states may include: determining a current assignment state by assigning representative neural update models selected between the first and second update models to the nodes, respectively; and updating the node states of the nodes based on the aggregated messages in the current assignment state.

The method may further include: changing the current assignment state to a test assignment state by changing an assignment state of at least a portion of the representative neural update models; updating the node states of the nodes based on test messages in the test assignment state; and determining whether to maintain the current assignment state based on a result of comparison between a task performance based on the current assignment state and a task performance based on the test assignment state.

The method may further include determining the node states corresponding to the input graph data using an encoder.

The outputting of the task result may include generating the task result according to the updated node states using a decoder.

The input graph data may be a graph neural network.

In another general aspect, an electronic device includes one or more processors and a memory storing instructions configured to cause the one or more processors to: generate messages based on node states of nodes of input graph data using a neural message generating model, generate aggregated messages by aggregating the messages, update the node states of the nodes by applying a first neural update model and a second neural network model to the aggregated messages, and output an inference with respect to the input graph data based on the updated node states.

The instructions may be further configured to cause the one or more processors to, for updating the node states: determine a first intermediate node state by executing a first neural update model of the neural update models based on a first aggregated message of the aggregated messages aggregated along a first node of the nodes, determine a second intermediate node state by executing a second neural update model of the neural update models based on the first aggregated message, and update a first node state of the first node by fusing the first intermediate node state and the second intermediate node state.

The instructions may be further configured to cause the one or more processors to, for updating the first node state: determine a fusion coefficient by executing a neural fusion model based on the input graph data, and perform the fusing of the first intermediate node state and the second intermediate node state based on the fusion coefficient.

The instructions may be further configured to cause the one or more processors to, for updating the node states: select a representative neural update model from between the first and second neural update models, update a first node state of a first node of the nodes by applying the first neural update model to a first aggregated message of the aggregated messages aggregated at the first node, based on the first neural update model being selected as the representative neural update model, and update the first node state by applying the second neural update model to the first aggregated message, when the second neural update model is selected as the representative neural update model.

The representative neural update model may be selected from between the first and second neural update models based on a probability model, and the probability model is a neural probability model configured to generate probability values for selecting the representative neural update model based on the input graph data.

The instructions may be further configured to cause the one or more processors to, for updating the node states: determine a current assignment state by assigning representative neural update models selected between the first and second neural update models to the nodes, respectively, and update the node states of the nodes based on the aggregated messages in the current assignment state.

In another general aspect, a method is performed by a computing device and the method includes performing an inference on a graph neural network including nodes having respective states and interconnected by edges, and the performing the inference includes: sending messages between the nodes, the messages based on the states of the nodes; for each of the nodes, generating a respectively corresponding aggregate message by aggregating the messages received thereby; for a first set of the nodes, setting the respective states of the nodes therein by performing inferences on the corresponding aggregate messages using a first neural update model; for a second set of the nodes, setting the respective states of the nodes therein by performing inferences on the corresponding aggregate messages using a second neural update model; and outputting the inference of the graph neural network based on the states of the nodes in the first set of nodes and the states of the nodes in the second set of nodes.

Other features and aspects will be apparent from the following detailed description, the drawings, and the claims.

### BRIEF DESCRIPTION OF THE DRAWINGS

FIG. 1 illustrates an example of operation of a neural network model, according to one or more embodiments.

FIG. 2 illustrates an example of processing of a graph neural network model, according to one or more embodiments.

FIG. 3 illustrates an example of processing input graph data using an encoder and a decoder, according to one or more embodiments.

FIG. 4 illustrates an example of fusion gating using a multi-update model, according to one or more embodiments.

FIG. 5 illustrates an example of selective gating by a multi-update model, according to one or more embodiments.

FIGS. 6 to 8 illustrate examples of meta learning of a multi-update model, according to one or more embodiments.

FIG. 9 illustrates an example graph processing method, according to one or more embodiments.

FIG. 10 illustrates an example configuration of an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

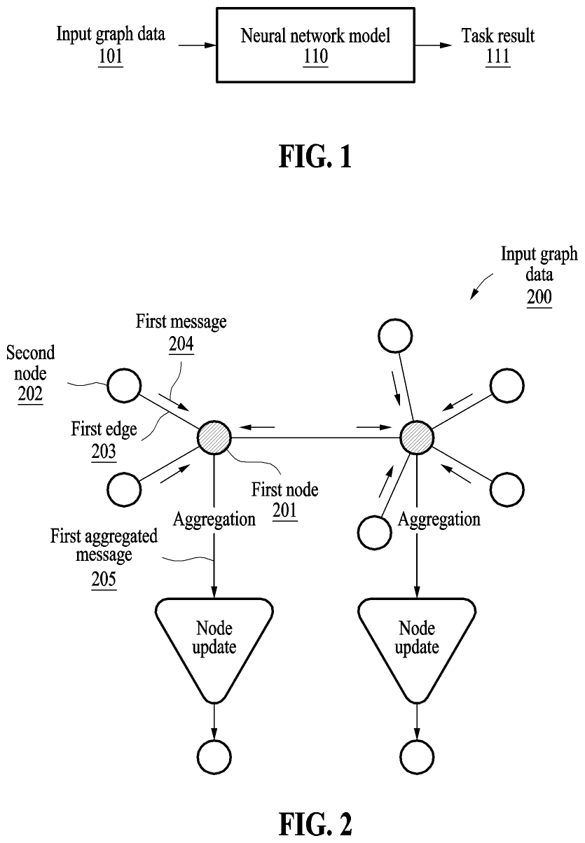

FIG. 1 illustrates an example operation of a neural network model, according to one or more embodiments. Referring to FIG. 1, a neural network model 110 may output a task result 111 based on (inferred from) input graph data 101. The neural network model 110 may include/be a neural network.

The neural network may be trained based on deep learning to perform inference suitable for the purpose of the training by mapping input data to output data that are in a non-linear relationship. Deep learning may involve machine learning techniques for solving a problem such as image or speech recognition from a large data set. Deep learning may be construed as an optimization problem solving process of finding a point at which energy is minimized while training a neural network using prepared training data (in the case of supervised learning). Through supervised or unsupervised deep learning, the structure of a neural network model or the weights of the model may be obtained, and the input data and the output data may be mapped to each other according to the structure/weights. If the width and the depth of the neural network are sufficient, the neural network may have a capacity sufficient to implement a predetermined function. The neural network may achieve an optimized performance when learning a sufficiently large amount of training data through an appropriate training process.

The neural network may be expressed as being trained in advance, where “in advance” means before the neural network “starts”. That the neural network “starts” means that the neural network is preparing for, or ready for, inference. For example, “starting” the neural network may include loading the neural network into a memory, or inputting data for inference into the neural network after the neural network is loaded into the memory.

According to an example, the neural network model 110 may be/include a graph neural network (GNN), or a type thereof. For example, the GNN may be a message-passing neural network (MPNN). The input graph data 101 may include data about a graph. The graph includes nodes and edges between the nodes. The nodes and edges may each have various features. That is, each node may have a same set of node features (with its own values thereof), and each edge may have a same of edge features (with its own values thereof). A message sent by a node may be generated based on the values of the features of the node. The input graph data 101 may include the graph itself, nodes of the graph, edges of the graph, features of the nodes, and/or features of the edges.

The neural network model 110 may be trained for various training purposes. When the neural network model 110 is trained, the neural network model 110 may derive the task result 111 according to a training purpose. The task result 111 may be a result of processing the input graph data 101. For example, the task result 111 may include a graph-level processing result (e.g., an inference about the graph itself) and/or a node-level processing result with respect to the input graph data 101 at a node level (e.g., an inference about particular node(s)). The graph-level processing result may be based on processing with respect to the entire graph, and the node-level processing result may be based on processing with respect to the nodes and/or edges (e.g., predicting new edges).

FIG. 2 illustrates an example of processing of a graph neural network model, according to one or more embodiments. Node states of nodes of input graph data 200 may be defined in the input graph data 200. In graph neural network processing, the nodes may exchange messages through edges, and the node states may be updated as the messages are exchanged and aggregated. For example, at one processing iteration (or time point), a first node 201 of the input graph data 200 may receive messages from nodes connected to the first node 201. For example, the first node 201 may be connected to a second node 202 through a first edge 203, and may receive a first message 204 from the second node 202 through the first edge 203. The messages received by the first node 201, including the first message 204, may be aggregated into a first aggregated message 205 (which may be retained by the first node 201 and later sent by the first node 201). The node state of the first node 201 may be updated based on the first aggregated message 205 (e.g., as per Equation 1 below).

It may be noted that the various “first nodes” described herein are representative of any of the nodes in a GNN, for example. Techniques described with reference to the “first nodes” may be applied to all nodes of a GNN, for example.

A graph neural network model may include/be a graph that is processed as a neural network, where the graph neural network model includes the input graph data 200. For example, the graph neural network model may include a neural message generating model for generating messages, a neural update model for updating node states, a neural fusion model, and/or a neural probability model. Each of the models are described later.

The process of updating each node state is expressed by Equation 1 below.

$${h}_{i}^{( t + 1 )} = u ( {h}_{i}^{( t )} , {⊕}_{( j , i ) ∈ ℰ} ℳ ( {h}_{i}^{( t )} , {h}_{j}^{( t )} , {z}_{i , j} ) ) \qquad Equation 1$$

In Equation 1, hᵢ^{(t+1)} denotes the node state of an i-th node at time t+1, [symbol] denotes a neural update model, hᵢ^{(t)} denotes the node state of the i-th node at time t, ⊕ denotes an aggregation operation (for aggregating messages from neighbors of the i-th node), [symbol] denotes a neural message generating model, hⱼ^{(t)} denotes the node state of a j-th node at time t, and z_{i,j} denotes a feature embedding vector of the i-th node, the j-th node, and a (j, i) edge. The nodes may be in a node set [symbol] , and the edges may be in an edge set ε. The input graph data 200 may include the node set [symbol] and the edge set ε. Task results may be determined by iterating the update operation of Equation 1 T times on the nodes in the node set [symbol] and the edges in the edge set ε.

According to an example, the node states may be updated using a multi-update model. The multi-update model may include different types of neural update models. An example of a multi-update model including a first neural network model and a second neural network model will be described below, but examples are not limited thereto. Different types of neural update models may have different architectures and/or different parameters (e.g., weights) for updating nodes. Using a multi-update model as described above may allow a GNN to have an improved generalization ability for a larger range of inputs and out-of-distribution inputs.

When a multi-update model is used, multiple neural update models may be used to update the node state of the first node 201 (i.e., a same node), or different neural update models may be used to update the node state of the first node 201 and the node state of the second node 202, respectively (i.e., different nodes). For example, a first intermediate node state may be determined by executing a first neural update model based on the first aggregated message 205 aggregated at the first node 201 (i.e., applying the first neural update model to the first aggregated message 205, and possibly other messages), a second intermediate node state may be determined by executing a second neural update model based on the first aggregated message 205, and the node state of the first node 201 may be updated by fusing the first intermediate node state and the second intermediate node state. As another example, when a representative neural update model is selected from among the multiple neural update models, and the first neural update model is selected as the representative neural update model, a first node state of the first node 201 may be updated by executing the first neural update model based on the first aggregated message 205 aggregated at the first node 201, and when the second neural update model is selected as the representative neural update model, the first node state may be updated by executing the second neural update model based on the first aggregated message 205.

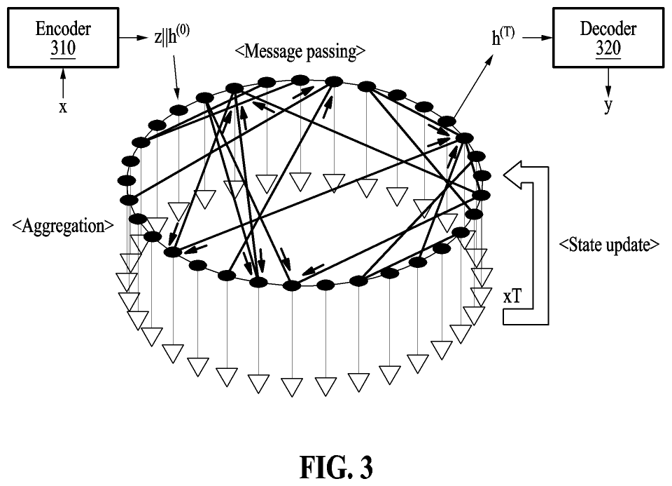

FIG. 3 illustrates an example of processing input graph data using an encoder and a decoder, according to one or more embodiments. Referring to FIG. 3, an encoder 310 may determine feature embedding vectors z and/or initial node states h⁽⁰⁾ corresponding to input graph data x. That is, the encoder 310 may encode features of the input graph data x (e.g., a GNN) into feature vectors that are then embeddings for the nodes or initial nodes states. Final node states h^{(T)} may be determined according to T iterative operation stages based on nodes and edges. Each operation stage may include a message passing phase, an aggregation phase, and a state update phase. A multi-update model may be used for stage updating in each iteration of the operation stage (i.e., any of the update models in the multi-update model may be used during any of the iterations of the operation stage). A decoder 320 may generate a task result y based on the final node states h^{(T)} (i.e., map the final node states to labels, categories, scores, etc., inferred using the multi-update model)

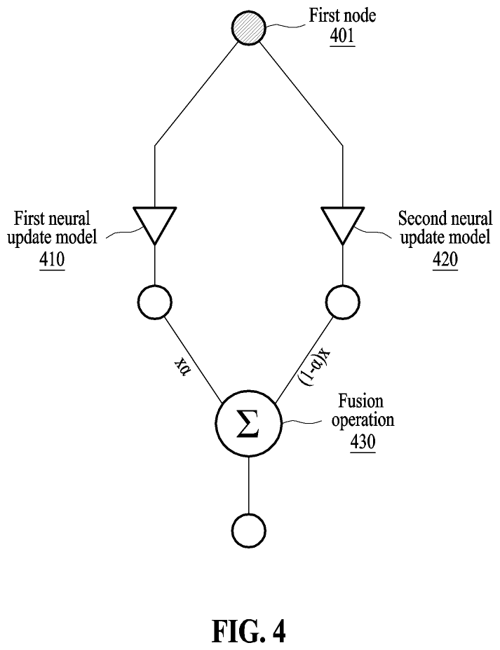

FIG. 4 illustrates an example of fusion gating using a multi-update model, according to one or more embodiments. Referring to FIG. 4, a multi-update model may include a first neural update model 410 and a second neural update model 420. However, examples are not limited thereto, and the multi-update model may further include other neural update models. When (1) a first intermediate node state is determined by executing the first neural update model 410 based on a first aggregated message of aggregated messages aggregated at a first node 401, and (2) a second intermediate node state is determined by executing the second neural update model 420 based on the first aggregated message, a first node state of the first node 401 may be updated by fusing the first intermediate node state and the second intermediate node state through a fusion operation 430. The first intermediate node state and the second intermediate node state may be fused based on a fusion coefficient α (a blending coefficient, e.g., between 0 and 1). A neural fusion model may determine the fusion coefficient α based on input graph data (described later).

According to an example, fusion gating may be performed based on Equation 2 below.

$${h}_{i}^{( t + 1 )} = {α}_{i}^{( t )} {h}_{i , 1}^{( t )} + ( 1 - {α}_{i}^{( t )} ) {h}_{i , 2}^{( t )} \qquad Equation 2$$

In Equation 2, hᵢ^{(t+1)} denotes the node state of an i-th node (e.g., first node 401) at time t+1, αᵢ^{(t)} denotes a fusion coefficient for the i-th node at time t, h_{t,1}^{(t)} denotes a first intermediate node state of the i-th node at time t, and h_{i,2}^{(t)} denotes a second intermediate node state of the i-th node at time t. The first intermediate node state h_{i,1}^{(t)} may be obtained using the first neural update model 410 as the neural update model in Equation 1 (e.g., applying the state or aggregated message of the i-th node to the first neural update model 410), and second intermediate node state h_{i,2}^{(t)} may be obtained using the second neural update model 420 as the neural update model in Equation 1 (e.g., applying the state or aggregated message of the i-th node to the second neural update model 410). The fusion coefficient αᵢ^{(t)} may be generated by the neural fusion model mentioned above. The neural fusion model may determine αᵢ^{(t)} based on the input graph data. The neural fusion model can be trained to generate optimal αᵢ^{(t)} that increases the accuracy of a task result based on the input graph data. For example, the neural fusion model can be trained based on loss of a GNN.

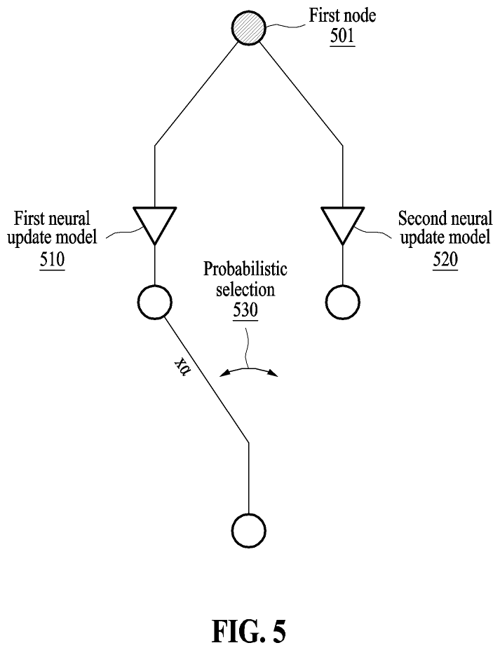

FIG. 5 illustrates an example of selective gating by a multi-update model, according to one or more embodiments. Referring to FIG. 5, a multi-update model may include a first neural update model 510 and a second neural network model 520, and a representative (active) neural update model may be selected from the first neural update model 510 and the second neural network model 520. However, examples are not limited thereto, and the multi-update model may further include other neural update models.

When the first neural update model 510 is selected as the representative neural update model, a first node state of a first node 501 (among other nodes) may be updated by executing the first neural update model 510 based on a first aggregated message of messages aggregated at the first node 501 (some of which may be aggregated messages aggregated by other/neighbor nodes). When the second neural update model 520 is selected as the representative neural update model, the first node state may be updated by executing the second neural update model 520 based on the first aggregated message. In other words, one or the other of the first and second neural update models are selected to update the first node 501.

In FIG. 4's example of fusion gating, the entire multi-update model may be used for each node (or at least potentially used). Unlike with selective gating, with fusion gating, a representative neural update model selected from the multi-update model may be used for each node. The same representative neural update model may be selected for all nodes (e.g., upon each iteration, or for all iterations), or a model may be selected for each node individually (again, upon each iteration, or for all iterations). The representative neural update model may be selected according to a probabilistic selection 530 using a probability model. The probability model may be a neural probability model configured to generate probability values for selecting the representative neural update model based on the input graph data.

According to an example, selective gating may be performed based on Equation 3 below.

$${α}_{i}^{( t )} = σ ( \frac{log ( {π}_{i}^{( t )} / ( 1 - {π}_{i}^{( t )} ) ) + ( {g}_{i , 1}^{( t )} - {g}_{i , 2}^{( t )} )}{τ} ) \qquad Equation 3$$

αᵢ^{(t)} may be set as a random variable with a Bernoulli distribution parameterized by πᵢ^{(t)}∈[0, 1], such that αᵢ^{(t)}˜Ber(πᵢ^{(t)}) may be satisfied (“Ber” denotes a Bernoulli distribution). In addition, a Gumbel reparameterization may be used, as expressed by Equation (t) 3, for improvement in terms of differentiability. In Equation 3, g_{i,1}^{(t)},g_{i,2}^{(t)}˜Gumbel(0, 1) may be satisfied. Gumbel denotes a Gumbel reparameterization. πᵢ^{(t)} denotes a probability value output by the neural probability model (for the i-th node and t-th iteration). T denotes the temperature. When T approaches “0”, αᵢ^{(t)}=1 may be satisfied with the probability of πᵢ^{(t)}. In the manner described above, αᵢ^{(t)} may be applied to Equation 2, and one of h_{i,1}^{(t)} and h_{i,2}^{(t)} by may be determined to be hᵢ^{(t+1)}.

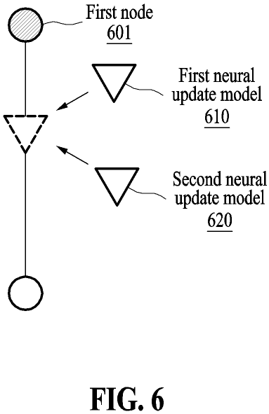

FIGS. 6 to 8 illustrate examples of meta learning of a multi-update model, according to one or more embodiments. Referring to FIG. 6, a multi-update model may include a first neural update model 610 and a second neural update model 620. However, examples are not limited thereto, and the multi-update model may include other/additional neural update models. A representative update model for a first node 601 may be assigned (selected), according to meta-learning, from among the first neural update model 610 and the second neural update model. Representative update models for all respective nodes of input graph data (e.g., a GNN) may be assigned according to meta-learning, and an assignment state thereof may be determined. An optimal assignment state (of representative update model selections) may be derived according to meta-learning.

According to meta-learning, in a state/case where neural update models are assigned to all nodes of a graph, an optimal generalized assignment state may be derived in out-of-distribution OOD settings by searching additional assignment states. More specifically, Θ=(θ₁, θ₂, θᵣₑₛₜ) may be set as model parameters of the first neural update model 610, the second neural update model 620, and the rest of the neural network model, respectively.

Meta-learning may include a meta-training phase and a meta-testing phase. In the meta-training phase, optimization of the assignment state and the model parameters may be performed, and in the meta-testing phase, a final single assignment state may be derived. The meta-training phase and the meta-testing phase may be performed alternately, repeatedly, to conduct an optimization search.

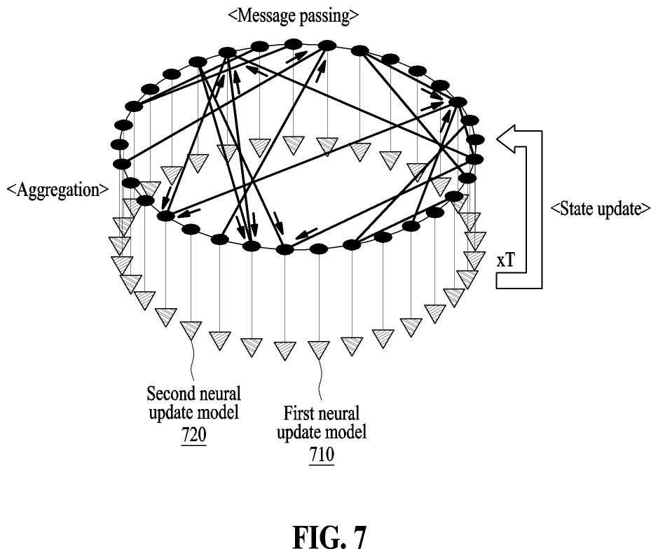

FIG. 7 illustrates an example of a meta-training phase, according to one or more embodiments. Referring to FIG. 7, in a meta-training phase, a current assignment state may be determined by assigning representative neural update models selected from neural update models to nodes, and node states of the nodes may be updated based on aggregated messages in the current assignment state.

Given a fixed set of model parameters Θ in the meta-training phase, an optimal assignment state [symbol] of the first neural update model 610 and the second neural update model 620 for nodes of a training graph [symbol] ᵢ^{train} may be determined. Then, the parameters Θ may be updated using test graphs [symbol] ᵢ^{test} while maintaining the previously determined assignment state [symbol] . A simulated annealing step for optimizing the assignment state [symbol] and a gradient descent step for optimizing the parameters Θ may be performed alternately. According to an example, these steps may be performed on Equation 4 below.

$$ℒ ( Θ ) = {\sum }_{i} ℓ ( {𝒢}_{i}^{test} , {arg min}_{{𝒜}_{i} ∈ 𝔸} ℓ ( {𝒢}_{i}^{train} , {𝒜}_{i} , Θ ) , Θ ) \qquad Equation 4$$

In Equation 4, [symbol] (Θ) denotes the final loss value according to the parameters Θ, [symbol] denotes an individual loss value according to each graph (e.g., [symbol] ᵢ^{train} or [symbol] ᵢ^{test}), each assignment state (e.g., [symbol] or [symbol] ᵢ), and the parameters Θ, i denotes a graph index, and [symbol] denotes possible assignment states.

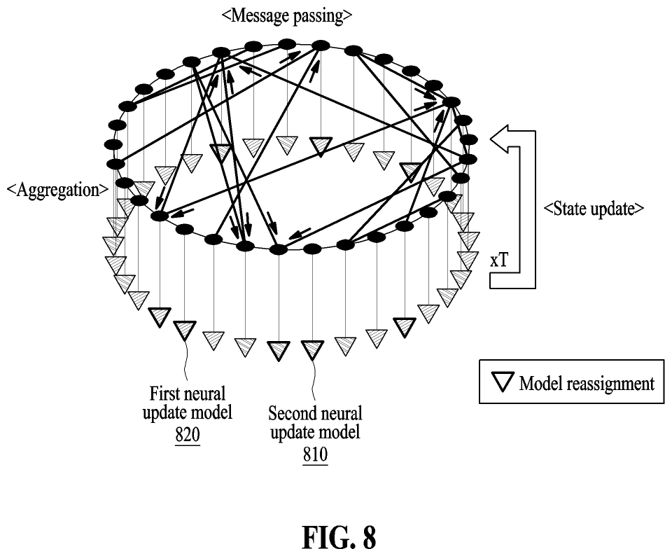

FIG. 8 illustrates an example of a meta-testing phase, according to one or more embodiments. In a meta-testing phase, a current assignment state may be changed to a test assignment state by changing an assignment state of at least a portion of representative neural update models (i.e., changing which update models are assigned to which nodes), the node states of nodes may be updated based on updates of test messages for the test assignment state; whether to maintain the current assignment state may be determined based on a result of comparison between (i) a task performance (score/measure/loss) based on the current assignment state and (ii) a task performance based on the test assignment state. For example, in response to the change of the assignment state, a first neural update model 710 and a second neural update model 720 in the assignment state of FIG. 7 may be replaced with (switched to) a second neural update model 810 and a first neural update model 820 in the assignment state of FIG. 8. If the current assignment state exhibits better task performance, the current assignment state may be selected, and if the test assignment state exhibits better task performance, the test assignment state may be selected.

In the meta-testing phase, a small number of final training graphs [symbol] ₘₑₜₐ₋ₜₑₛₜ^{train} may be used. The final training graphs [symbol] ₘₑₜₐ₋ₜₑₛₜ^{train} may not be OOD samples but may be a limited number of in-distribution graphs. An optimal assignment state may be derived for each individual graph (e.g., [symbol] ᵢ^{train} or [symbol] ᵢ^{test}) in a meta-training phase, and a single assignment state applicable to all graphs of [symbol] ₘₑₜₐ₋ₜₑₛₜ^{train} may be derived in the meta-testing phase. According to an example, the single assignment state may be derived based on Equation 5 below.

$${𝒜}^{*} = {arg min}_{𝒜 ∈ 𝔸} ℓ ( {𝒢}_{meta - test}^{train} , 𝒜 , Θ ) \qquad Equation 5$$

In Equation 5, [symbol] * denotes a single assignment state. Among possible assignment states [symbol] , an assignment state [symbol] that minimizes a loss value [symbol] may be determined to be the single assignment state [symbol] *.

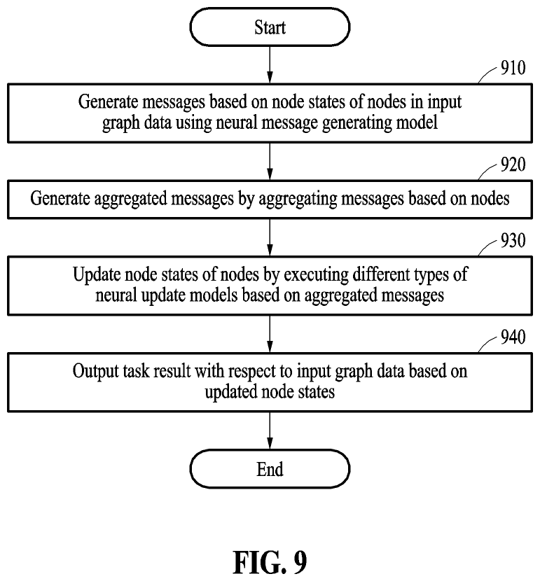

FIG. 9 illustrates an example of a graph processing method, according to one or more embodiments. Referring to FIG. 9, in operation 910, an electronic device may generate messages based on node states of nodes of input graph data using a neural message generating model (e.g., a GNN). In operation 920 the electronic device may generate aggregated messages by aggregating the messages based on the nodes, and in operation 930 update the node states of the nodes by executing different types (or instances) of neural update models on the aggregated messages. In operation 940, the electronic device may output a task result with respect to the input graph data based on the updated node states.

Operation 920 may include an operation of generating the messages by executing the neural message generating model based on the node states of the node and embedding features of the nodes and edges of the nodes in the neural message generating model. In some cases, the messages (received in operation 910) may themselves be messages previously generated by message aggregation and node status updating.

The neural update models may have different architectures and/or different parameters.

Operation 930 may include an operation of (i) determining a first intermediate node state (e.g., of a first node of the nodes) by executing a first neural update model (from among the neural update models) on a first aggregated message (of the aggregated messages aggregated at the first node of the nodes), an operation of (ii) determining a second intermediate node state by executing a second neural update model (from among the neural update models) on the first aggregated message, and an operation of updating the state of the first node by fusing the first intermediate node state and the second intermediate node state.

The operation of updating the state of the first node may include an operation of determining a fusion coefficient by executing a neural fusion model based on the input graph data (i.e., any data of the graph) to infer the fusion coefficient, and an operation of fusing the first intermediate node state and the second intermediate node state based on the fusion coefficient.

Operation 930 may include an operation of selecting a representative neural update model from the neural update models, an operation of updating state of a first node of the nodes by executing a first neural update model (among the neural update models) based on a first aggregated message (of the aggregated messages aggregated at the first node), when the first neural update model is selected as the representative neural update model, and an operation of updating the state of the first node by executing a second neural update model (among the neural update models) based on the first aggregated message, when the second neural update model is selected as the representative neural update model.

The representative neural update model may be selected based on a probability model. The probability model may be a neural probability model configured to generate probability values for selecting the representative neural update model based on the input graph data (e.g., any data of a GNN, e.g., initial node states, cardinalities of edges/nodes, etc.).

Operation 930 may include determining a current assignment state by assigning representative neural update models selected from the neural update models to the nodes, respectively, and an operation of updating the node states of the nodes based on the aggregated messages in the current assignment state.

In addition, the electronic device may change the current assignment state to a test assignment state by changing an assignment state of at least a portion of the representative neural update models (of respective nodes), update the node states of the nodes based on test messages in the test assignment state, and determine whether to maintain the current assignment state based on a result of comparison between a task performance based on the current assignment state and a task performance based on the test assignment state.

The electronic device may determine the node states corresponding to the input graph data using an encoder. Operation 940 may include an operation of generating the task result according to the updated node states using a decoder.

In addition, the description provided with reference to FIGS. 1 to 8 and 10 may apply to the graph processing method of FIG. 9.

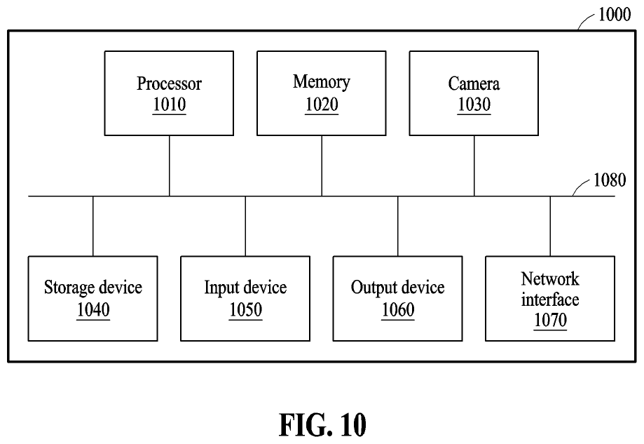

FIG. 10 illustrates an example of an electronic device, according to one or more embodiments. Referring to FIG. 10, an electronic device 1000 may include a processor 1010, a memory 1020, a camera 1030, a storage device 1040, an input device 1050, an output device 1060, and a network interface 1070 that may communicate with each other through a communication bus 1080. For example, the electronic device 1000 may be implemented as at least a part of a mobile device such as a mobile phone, a smart phone, a PDA, a netbook, a tablet computer or a laptop computer, a wearable device such as a smart watch, a smart band or smart glasses, a computing device such as a desktop or a server, a home appliance such as a television, a smart television or a refrigerator, a security device such as a door lock, or a vehicle such as an autonomous vehicle or a smart vehicle.

The processor 1010 executes functions and instructions to be executed in the electronic device 1000. For example, the processor 1010 may process instructions stored in the memory 1020 or the storage device 1040. The processor 1010 may perform the operations described with reference to FIGS. 1 to 9. For example, the processor 1010 may generate messages based on node states of nodes of input graph data using a neural message generating model, generate aggregated messages by aggregating the messages based on the nodes, update the node states of the nodes by executing different types of neural update models based on the aggregated messages, and output a task result with respect to the input graph data based on the updated node states.

The memory 1020 may include a computer-readable storage medium or a computer-readable storage device. The memory 1020 may store instructions to be executed by the processor 1010 and may store related information while software and/or an application is executed by the electronic device 1000.

The camera 1030 may capture a photo and/or record a video. The storage device 1040 includes a computer-readable storage medium or computer-readable storage device. The storage device 1040 may store a more quantity of information than the memory 1020 for a long time. For example, the storage device 1040 may include a magnetic hard disk, an optical disc, a flash memory, a floppy disk, or other non-volatile memories known in the art.

The input device 1050 may receive an input from the user in traditional input manners through a keyboard and a mouse, and in new input manners such as a touch input, a voice input, and an image input. For example, the input device 1050 may include a keyboard, a mouse, a touch screen, a microphone, or any other device that detects the input from the user and transmits the detected input to the electronic device 1000. The output device 1060 may provide an output of the electronic device 1000 to the user through a visual, auditory, or haptic channel. The output device 1060 may include, for example, a display, a touch screen, a speaker, a vibration generator, or any other device that provides the output to the user. The network interface 1070 may communicate with an external device through a wired or wireless network.

Although operations are described above using mathematical notation, it will be appreciated that the mathematical notation is merely a convenient language with which to efficiently describe the physical operations of physical circuits (e.g., bits, gates, etc.). The portions of description herein that use mathematical notation may be readily reduced to source code and/or circuit designs using ordinary software/hardware development/design tools, and such code/designs may be readily reduced to physical devices that operate as described herein.

In addition, it will be appreciated that neural networks, and in particular, graph neural networks, are convenient tools for performing many arbitrary types of computing tasks (e.g., inferring outputs for arbitrary inputs). Techniques described herein may improve the accuracy or efficiency of graph neural networks (and others). Therefore, it can be readily appreciated that the methods and devices described herein provide improvements in the field of neural network computing and naturally improve the efficiency of computing devices when they execute various kinds of neural networks such as graph neural networks.

The electronic devices, the processors, the memories, the graphs, the neural networks, the displays, the information output system and hardware, the storage devices, and other apparatuses, devices, units, modules, and components described herein with respect to FIGS. 1-10 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-10 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A graph processing method performed by a computing device comprising processing hardware and storage hardware, the method comprising:
generating, by the processing hardware, and storing in the storage hardware, messages based on node states of nodes of input graph data stored in the storage hardware using a neural message generating model stored in the storage hardware;
generating, by the processing hardware, aggregated messages by aggregating the messages;
updating the node states of the nodes by applying a first neural update model and a second neural update model to the aggregated messages; and
outputting an inference with respect to the input graph data based on the updated node states.

2. The graph processing method of claim 1, wherein the messages are generated by executing the neural message generating model based on the node states of the nodes, embedding features of the nodes, and edges of the nodes.

3. The graph processing method of claim 1, wherein the first neural update model has a different architecture or different parameters than the second neural update model.

4. The graph processing method of claim 1, wherein the updating of the node states comprises, by the processing hardware:
determining a first intermediate node state of a first node, among the nodes, by applying the first neural update model to a first aggregated message, among the aggregated messages, that is aggregated at the first node;
determining a second intermediate node state of the first node by applying the second neural update model to the first aggregated message; and
updating a state of the first node by fusing the first intermediate node state and the second intermediate node state.

5. The graph processing method of claim 4, further comprising:
determining a fusion coefficient by executing a neural fusion model based on the input graph data; and
performing the fusing of the first intermediate node state and the second intermediate node state based on the fusion coefficient.

6. The graph processing method of claim 1, wherein the updating of the node states comprises:
selecting a representative neural update model from between the first and second neural update models;
updating a first node state of a first node of the nodes by applying the first neural update model to a first aggregated message of the aggregated messages aggregated at the first node, based on the first neural update model being selected as the representative neural update model; and
updating the first node state by applying the second neural update model to the first aggregated message, when the second neural update model is selected as the representative neural update model.

7. The graph processing method claim 6, wherein the representative neural update model is selected based on a probability model.

8. The graph processing method of claim 7, wherein the probability model is a neural probability model configured to generate probability values for selecting the representative neural update model based on the input graph data.

9. The graph processing method of claim 1, wherein the updating of the node states comprises:
determining a current assignment state by assigning representative neural update models selected between the first and second update models to the nodes, respectively; and
updating the node states of the nodes based on the aggregated messages in the current assignment state.

10. The graph processing method of claim 9, further comprising:
changing the current assignment state to a test assignment state by changing an assignment state of at least a portion of the representative neural update models;
updating the node states of the nodes based on test messages in the test assignment state; and
determining whether to maintain the current assignment state based on a result of comparison between a task performance based on the current assignment state and a task performance based on the test assignment state.

11. The graph processing method of claim 1, further comprising:
determining the node states corresponding to the input graph data using an encoder.

12. The graph processing method of claim 1, wherein the outputting of the task result comprises generating the task result according to the updated node states using a decoder.

13. The graph processing method of claim 1, wherein the input graph data comprises a graph neural network.

14. An electronic device comprising:
one or more processors; and
a memory storing instructions configured to cause the one or more processors to:
generate messages based on node states of nodes of input graph data using a neural message generating model,
generate aggregated messages by aggregating the messages,
update the node states of the nodes by applying a first neural update model and a second neural network model to the aggregated messages, and
output an inference with respect to the input graph data based on the updated node states.

15. The electronic device of claim 14, wherein the instructions are further configured to cause the one or more processors to, for updating the node states:
determine a first intermediate node state by executing a first neural update model of the neural update models based on a first aggregated message of the aggregated messages aggregated along a first node of the nodes,
determine a second intermediate node state by executing a second neural update model of the neural update models based on the first aggregated message, and
update a first node state of the first node by fusing the first intermediate node state and the second intermediate node state.

16. The electronic device of claim 15, wherein the instructions are further configured to cause the one or more processors to, for updating the first node state:
determine a fusion coefficient by executing a neural fusion model based on the input graph data, and
perform the fusing of the first intermediate node state and the second intermediate node state based on the fusion coefficient.

17. The electronic device of claim 14, wherein the instructions are further configured to cause the one or more processors to, for updating the node states:
select a representative neural update model from between the first and second neural update models,
update a first node state of a first node of the nodes by applying the first neural update model to a first aggregated message of the aggregated messages aggregated at the first node, based on the first neural update model being selected as the representative neural update model, and
update the first node state by applying the second neural update model to the first aggregated message, when the second neural update model is selected as the representative neural update model.

18. The electronic device of claim 17, wherein
the representative neural update model is selected from between the first and second neural update models based on a probability model, and
the probability model is a neural probability model configured to generate probability values for selecting the representative neural update model based on the input graph data.

19. The electronic device of claim 14, wherein the instructions are further configured to cause the one or more processors to, for updating the node states:
determine a current assignment state by assigning representative neural update models selected between the first and second neural update models to the nodes, respectively, and
update the node states of the nodes based on the aggregated messages in the current assignment state.

20. A method performed by a computing device, the method comprising:
performing an inference on a graph neural network comprising nodes having respective states and interconnected by edges, the performing the inference comprising:
sending messages between the nodes, the messages based on the states of the nodes;
for each of the nodes, generating a respectively corresponding aggregate message by aggregating the messages received thereby;
for a first set of the nodes, setting the respective states of the nodes therein by performing inferences on the corresponding aggregate messages using a first neural update model;
for a second set of the nodes, setting the respective states of the nodes therein by performing inferences on the corresponding aggregate messages using a second neural update model; and
outputting the inference of the graph neural network based on the states of the nodes in the first set of nodes and the states of the nodes in the second set of nodes.
